(19) United States
(12) Patent Application Publication
(10) Pub. No.: US 2015/0349627 A1
(43) Pub. Date: Dec. 3, 2015

(54) LLC RESONANT POWER CONVERTER

(71) Applicant: Wistron Corporation, New Taipei City (TW)

(72) Inventors: Shun-Chang Lin, Taipei (TW); Shao-Tseng Lee, New Taipei City (TW)

(21) Appl. No.: 14/556,937

(22) Filed: Dec. 1, 2014

(30) Foreign Application Priority Data
May 30, 2014 (TW) 103119077

(51) Int. Cl. H02M 1/44; H02M 1/088; H02M 3/335

(52) U.S. Cl. CPC H02M 1/44; H02M 3/33507; H02M 1/088

(57) ABSTRACT

A LLC resonant power converter for converting an input voltage from a direct current power source into an output voltage includes a first power switch, a second power switch, a transformer, a rectifying filter circuit, a LLC resonant circuit including a resonant inductor, a magnetizing inductor, and a variable capacitor that are electrically connected in series, a controller that controls the first power switch and the second power switch to be alternately switched to an on-state and that controls the variable capacitor to have a first capacitance value or a second capacitance value when the controller determines that the input voltage is within a first voltage range or a second voltage range, respectively.

### CROSS-REFERENCE TO RELATED APPLICATION

This application claims priority of Taiwanese application no. 103119077, filed on May 30, 2014.

### FIELD OF THE INVENTION

The present invention relates to a LLC resonant power converter for converting an input voltage from a direct current power source into an output voltage.

### BACKGROUND OF THE INVENTION

Referring to FIG. 1, a conventional LLC resonant power converter 1 mainly includes a first power switch S1 and a second power switch S2 electrically connected in series. Both the first power switch S1 and the second power switch S2 are electrically coupled with a direct current power source 10, receive an input voltage Vdc, and are controlled by a controller 11 to be alternately switched to an on-state. A LLC resonant circuit 12 is electrically coupled between the second power switch S2 and a primary side coil Lp of a transformer T. A rectifying filter circuit 13 is electrically coupled with a secondary coil side Ls of the transformer T, and rectifies and filters the voltage received from the secondary coil side Ls to provide an output voltage Vo.

The LLC resonant circuit 12 includes a resonant capacitor Cᵣ, a leakage inductor Lr of the primary side coil Lₚ of the transformer T, and a magnetizing inductor Lₘ, and thus a resonant frequency fₛ of the LLC resonant circuit 12 is determined by the magnetizing inductor Lₘ, the leakage inductor Lᵣ and the resonant capacitor Cr. The resonant frequency fₛ is in a range between a first resonant frequency fᵣ₁ and a second resonant frequency fr₂, i.e., fᵣ₁>fₛ>fᵣ₂. The first resonant frequency fᵣ₁ is determined by the leakage inductor Lr and the resonant capacitor Cr, the second resonant frequency fr₂ is determined by the magnetizing inductor Lₘ, the leakage inductor Lr and the resonant capacitor Cr, and the relevant equations are as follows:

$${f}_{r 1} = \frac{1}{2 π \sqrt{{L}_{r} \times {C}_{r}}}$$

$${f}_{r 2} = \frac{1}{2 π \sqrt{( {L}_{r} + {L}_{m} ) \times {C}_{r}}}$$

If the magnetizing inductor Lₘ is 300 uH, the leakage inductor Lᵣ is 75 uH, the resonant capacitor Cr is 27 nF, and the input voltage V_{dc} is a high voltage, such as 367V, the resonant frequency fₛ is 110.3 KHz. As shown in FIG. 2, a resonant current waveform approximates a sinusoidal wave. As the resonant current is a small value that results in a small conduction loss, the conversion efficiency is high (output power 62.5 W/input power 69.1 W=90.45%).

However, if the input voltage V_{dc} is a lower voltage, such as 126V, the resonant frequency fₛ is lowered to about 63.48 KHz, as shown in FIG. 3. Notches appear in peaks and valleys of the resonant current waveform, and as the resonant current is a larger value that results in a larger conduction loss, the conversion efficiency is lower (output power 62.5 W/input power 73.3 W=85.2%).

From the above equations, reducing a capacitance value of the resonant capacitor Cr increases the resonant frequency f₃, thus improving conversion efficiency for a low input voltage V_{dc}. However, in order to increase the resonant frequency fₛ, a resonant capacitor Cr having a smaller capacitance is used (such as 15 nF). For an instance when the input voltage V_{dc} is 367V (as shown in FIG. 4), the resonant frequency fₛ is increased from 110.3 Khz to 158.6 Khz. Although a conversion efficiency (output power 62.5 W/input power 68.5 W=91.24%) has increased, an operation frequency of the LLC resonant circuit 12 has increased to over 150 Khz. Such high frequency operations affect circuit stability, can easily lead to erroneous circuit operation, and increases electromagnetic interference (EMI).

### SUMMARY OF THE INVENTION

The object of the present invention is to provide a LLC resonant power converter that improves power conversion efficiency for both low and high input voltages.

According to one aspect of the present invention, there is provided a LLC resonant power converter for converting an input voltage from a direct current power source into an output voltage, the input voltage being within a first voltage range or within a second voltage range that is greater than the first voltage range. The LLC resonant power converter comprises:

a first power switch;

a second power switch electrically coupled in series with the first power switch;

a transformer including a primary side coil and a secondary side coil;

a rectifying filter circuit electrically coupled with the secondary side coil;

a LLC resonant circuit electrically coupled between the second power switch and the primary side coil, the LLC resonant circuit including a resonant inductor, a magnetizing inductor, and a variable capacitor that are electrically connected in series, the variable capacitor being controllable to have a selected one of a first capacitance value and a second capacitance value, the first capacitance value being less than the second capacitance value; and

a controller that controls the first power switch and the second power switch to be alternately switched to an on-state and that is electrically coupled with the direct current power source and the variable capacitor, the controller controlling the variable capacitor to have the first capacitance value when the controller determines that the input voltage is within the first voltage range, and controlling the variable capacitor to have the second capacitance value when the controller determines that the input voltage is within the second voltage range.

According to another aspect of the present invention, there is provided a LLC resonant power converter for converting an input voltage from a direct current power source into an output voltage. The LLC resonant power converter comprises:

a first power switch;

a second power switch electrically coupled in series with the first power switch;

a transformer including a primary side coil and a secondary side coil;

a LLC resonant circuit that is electrically coupled between the second power switch and the primary side coil, the LLC resonant circuit including a resonant inductor, a magnetizing inductor, and a variable capacitor that are electrically connected in series; and

a controller that controls the first power switch and the second power switch to be alternately switched to an on-state and that is electrically coupled with the direct current power source and the variable capacitor, the controller controlling a capacitance of the variable capacitor according to a magnitude of the input voltage, such that the capacitance of the variable capacitor is increased when the input voltage is increased, and that the capacitance of the variable capacitor is decreased when the input voltage is decreased.

### BRIEF DESCRIPTION OF THE DRAWINGS

Other features and advantages of the present invention will become apparent in the following detailed description of the embodiments with reference to the accompanying drawings, of which:

FIG. 1 is a circuit diagram of a conventional LLC resonant power converter;

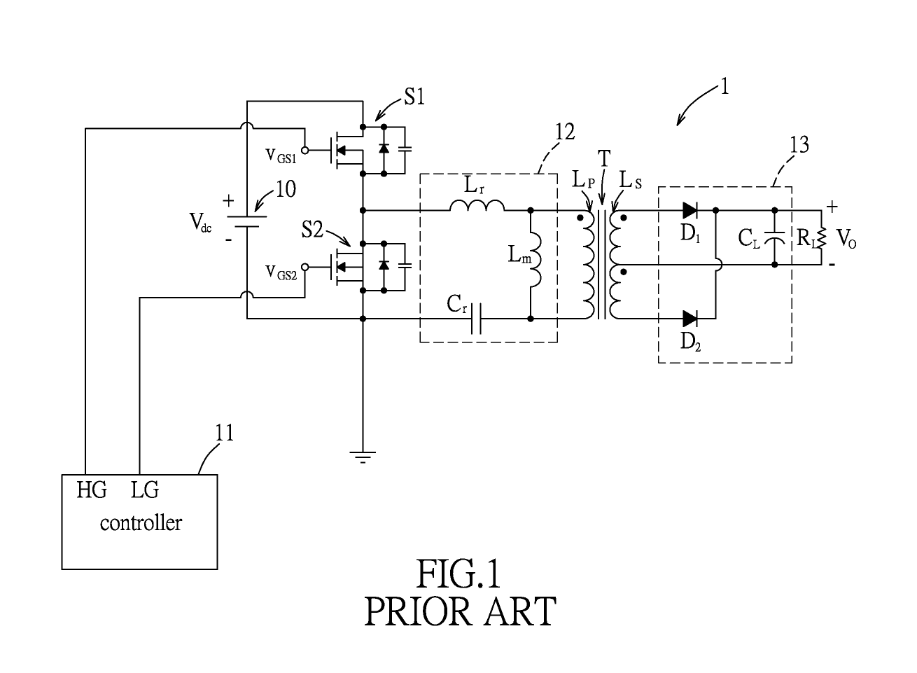

FIG. 2 is an illustration of a resonant current waveform of the conventional LLC resonant power converter resulting from a high input voltage;

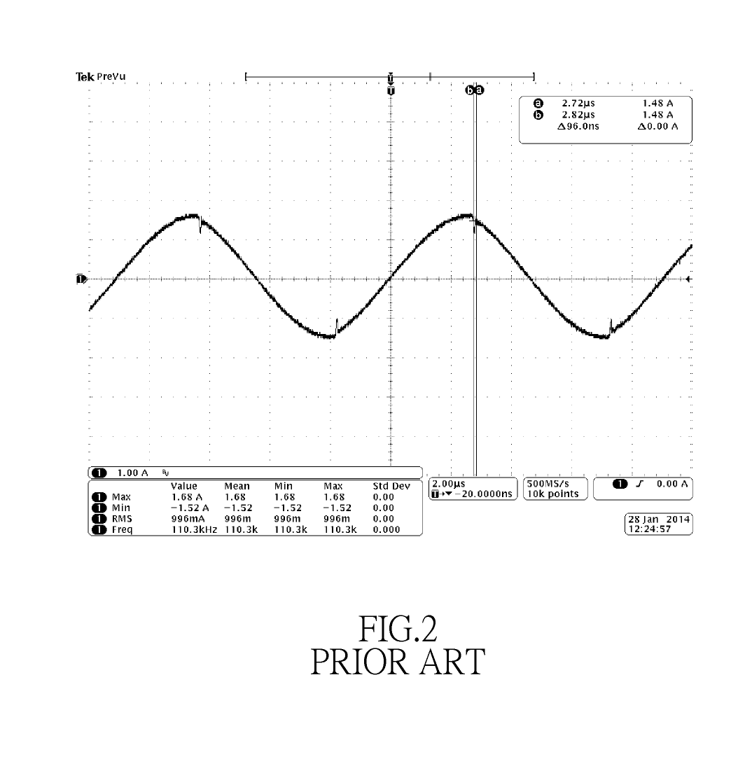

FIG. 3 is an illustration of a resonant current waveform of the conventional LLC resonant power converter resulting from a low input voltage;

FIG. 4 is an illustration of a resonant current waveform of the conventional LLC resonant power converter resulting from a high input voltage and when capacitance of a resonant capacitor is reduced;

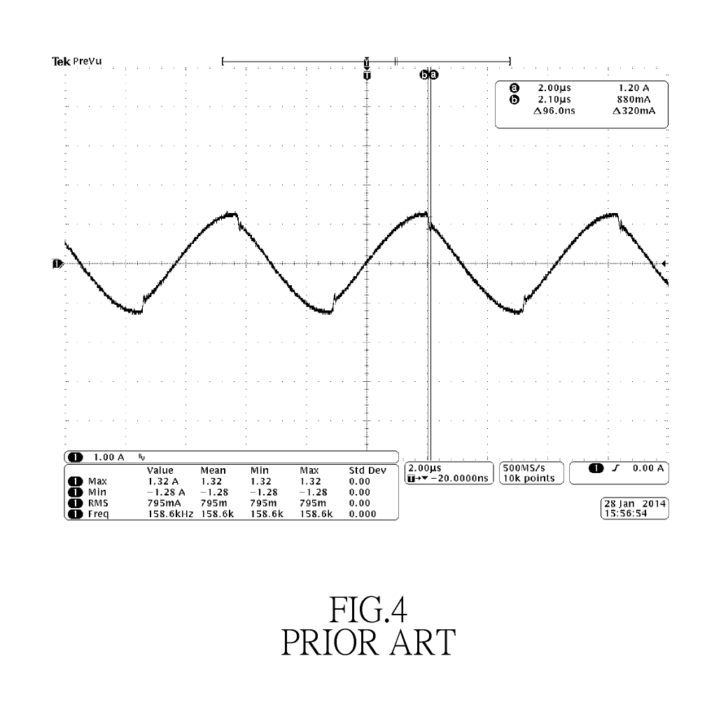

FIG. 5 is a circuit diagram of a LLC resonant power converter of a first embodiment in the present invention;

FIG. 6 is an illustration of a resonant current waveform of the first embodiment of the LLC resonant power converter in the present invention, resulting from a low input voltage; and

FIG. 7 is a circuit diagram of a LLC resonant power converter of a second embodiment in the present invention.

### DETAILED DESCRIPTION OF THE EMBODIMENTS

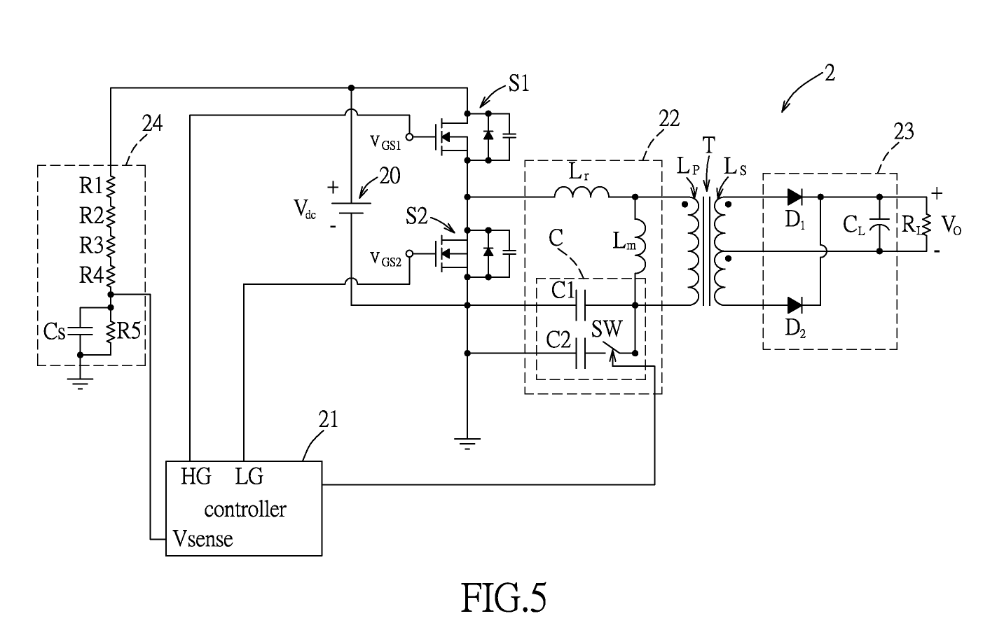

FIG. 5 shows a first embodiment of the LLC resonant power converter 2 in the present invention, which is for converting an input voltage V_{dc} (such as 126V-370V) from a direct current power source 20 into a stable output voltage Vₒ (such as 24V). The input voltage V_{dc} is within a first voltage range (such as 126V-245V) or within a second voltage range (246V-370V) that is greater than the first voltage range. The LLC resonant power converter 2 includes a first power switch S₁, a second power switch S₂ electrically coupled in series with the first power switch S₁, a controller 21 that controls conduction and non-conduction of the first power switch S₁ and the second power switch S₂, a transformer T, a LLC resonant circuit 22, and a rectifying filter circuit 23.

The transformer T includes a primary side coil Lₚ and a secondary side coil L₃, and the primary side coil Lₚ includes a leakage inductor. The LLC resonant circuit 22 is electrically coupled between the second power switch S₂ and the primary side coil Lₚ of the transformer T, and includes a resonant inductor Lᵣ, a magnetizing inductor Lₘ, and a variable capacitor C that are electrically connected in series. The resonant inductor Lᵣ is a leakage inductor of the primary side coil Lₚ of the transformer T. In other embodiments, the resonant inductor Lᵣ includes both the leakage inductor of the primary side coil Lₚ of the transformer T and an inductor electrically coupled with the leakage inductor in series (not shown). The rectifying filter circuit 23 is electrically coupled with the secondary side coil L₃.

When the input voltage V_{dc} is supplied, the controller 21 controls the controls the first power switch S₁ and the second power switch S₂ to be alternately switched to an on-state. This causes the magnetizing inductor Lₘ to be magnetized, and the magnetizing inductor Lₘ to produce an electromotive force and a back electromotive force repeatedly, which produce an induced voltage on the secondary side coil Ls of the transformer T. The induced voltage is rectified and filtered by the rectifying filter circuit 23 to produce the output voltage Vₒ to a load RL. The controller 21 controls the first power switch S₁ and the second power switch S₂ by a 50% duty cycle and frequency modulation, for outputting a stable output voltage Vₒ. During resonation of the LLC resonant circuit 22, the first power switch S₁ and the second power switch S₂ achieve zero voltage switching by virtue of parasitic capacitors and parasitic diodes of the first power switch S₁ and the second power switch S₂.

The resonant frequency fₛ of the LLC resonant circuit 22 is determined by the magnetizing inductor Lₘ, the resonant inductor Lᵣ, and variable capacitor C, and the resonant frequency fₛ is in a range between a first resonant frequency fr₁ and a second resonant frequency fr₂, i.e., fᵣ₁>fₛ>fᵣ₂. The first resonant frequency fr₁ is determined by the leakage inductor Lᵣ and the variable capacitor C, and the second resonant frequency fr₂ is determined by the magnetizing inductor Lₘ, the leakage inductor Lᵣ and the variable capacitor C. The relevant equations of the first resonant frequency fr₁ and the second resonant frequency fr₂ are as the follows:

$${f}_{r 1} = \frac{1}{2 π \sqrt{{L}_{r} \times C}}$$

$${f}_{r 2} = \frac{1}{2 π \sqrt{( {L}_{r} + {L}_{m} ) \times C}}$$

The above equations show that when the variable capacitor C is increased or decreased, the resonant frequency fₛ will correspondingly be reduced or increased.

In order to appropriately adjust the resonant frequency fₛ of the LLC resonant circuit 22 for the LLC resonant power converter 2 to operate efficiently, the variable capacitor C is controllable to have a selected one of a first capacitance value and a second capacitance value, and the first capacitance value is less than the second capacitance value. The controller 21 not only controls the first power switch S₁ and the second power switch S₂ to be alternately switched to an on-state, the controller 21 is also electrically coupled with the direct current power source 20 and the variable capacitor C for detecting whether the input voltage V_{dc} is within the first voltage range or within the second voltage range. The controller 21 controls the variable capacitor C to have the first capacitance value when the controller 21 determines that the input voltage V_{dc} is within the first voltage range (low voltage range), such that the resonant frequency fₛ of the LLC resonant circuit 22 is increased. Correspondingly, a switching frequency of the first power switch S₁ and the second power switch S₂ is increased, and thus conversion efficiency of the LLC resonant power converter 2 at a low input voltage V_{dc} is increased.

The controller 21 controls the variable capacitor C to have the second capacitance value when the controller 21 determines that the input voltage V_{dc} is within the second voltage range (high voltage range), such that the resonant frequency fₛ of the LLC resonant circuit 22 is decreased. Correspondingly, a switching frequency of the first power switch S₁ and the second power switch S₂ is decreased, and thus preventing erroneous circuit operation and high EMI due to high switching frequency of the first power switch S₁ and the second power switch S₂.

Referring to FIG. 5, the first embodiment further includes an input voltage detection circuit 24 electrically coupled with a positive terminal of the direct current power source 20 and a voltage detection terminal Vₛₑₙₛₑ of the controller 21. The voltage detection circuit 24 includes a plurality of resistors R1-R5 electrically coupled in series, and a stabilizing capacitor Cs electrically connected in parallel with the resistor R5. A terminal of the resistor R1 is electrically connected with the positive terminal of the direct current power source 20, and the voltage detection terminal Vₛₑₙₛₑ of the controller 21 is electrically connected with a non-grounded terminal of the stabilizing capacitor Cₛ for detecting a voltage drop value, which is a voltage drop across the resistor R5 in this embodiment. The controller 21 determines whether the input voltage V, is within the first voltage range or the second voltage range based on the voltage drop value. In other embodiments, the resistors R1-R4 may be omitted, and the voltage detection circuit 24 may only include the resistor R5 and the stabilizing capacitor Cs electrically connected in parallel. Alternatively, the stabilizing capacitor Cs can be omitted, and the voltage detection circuit 24 may only include the resistor R5 or the resistors R1-R5 electrically connected in series.

In this embodiment, the variable capacitor C includes a first capacitor C₁ and a second capacitor C₂. The first capacitor C₁ is electrically connected in series with the resonant inductor Lᵣ and the magnetizing inductor Lₘ, and the second capacitor C₂ is coupled to the first capacitor C₁ by a switch SW.

When the controller 21 determines the input voltage V_{dc} as being within the first voltage range (low voltage range), the controller 21 controls the switch SW of the variable capacitor C to break parallel connection of the second capacitor C₂ with the first capacitor C₁, such that the variable capacitor C has a first capacitance value equal to capacitance of the first capacitor C₁.

When the controller 21 determines the input voltage V_{dc} as being within the second voltage range (high voltage range), the controller 21 controls the switch SW of the variable capacitor C to make parallel connection of the second capacitor C₂ with the first capacitor C₁, such that the variable capacitor C has a second capacitance value that is a sum of the first capacitance value and a capacitance value of the second capacitor C₂.

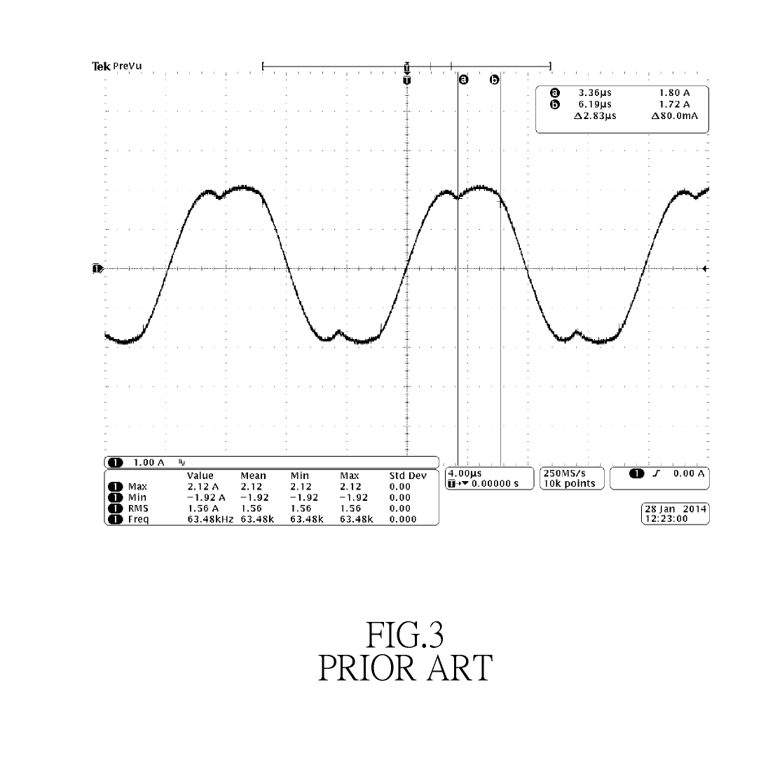

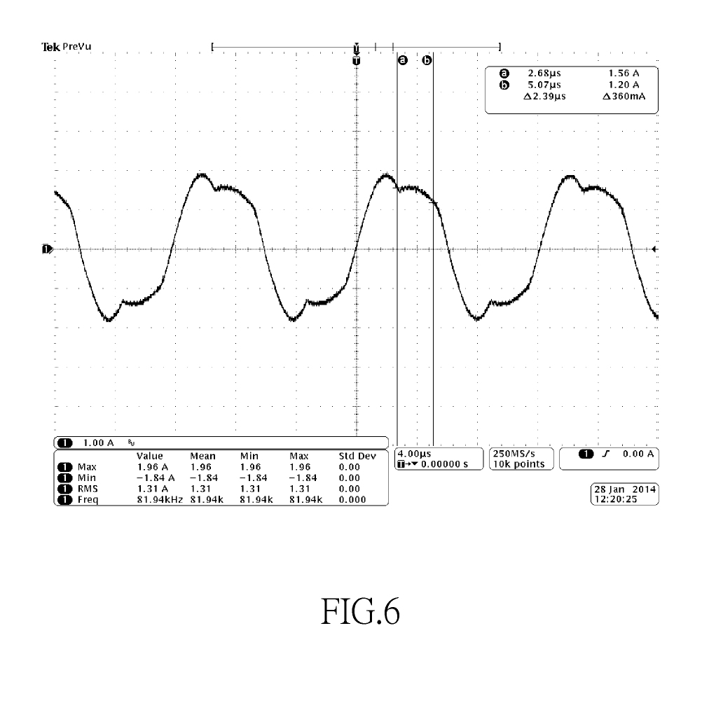

For example, if the magnetizing inductor Lₘ is 300 uH, the resonant inductor Lᵣ is 75 uH, the first capacitor C₁ is 15 nF and the second capacitor C₂ is 12 nF, the input voltage V_{dc} is 126V (low voltage range), the controller controls the variable capacitor C to have the capacitance of the first capacitor C₁, which is 15 nF. From a resonant current waveform as shown in FIG. 6, the resonant frequency fₛ of the LLC resonant circuit 22 can be increased to about 81.94 Khz. This enables the LLC resonant circuit 22 to operates in a higher frequency (the first power switch S₁ and the second power switch S₂ operating in a higher switching frequency) when the input voltage V_{dc} is in the low voltage range. Compared to the resonant capacitor Cᵣ (see FIG. 3), the resonant current is smaller and thus the conduction loss is smaller. The conversion efficiency is also increased by 1.7% (output power 62.5 W/input power 71.9 W=86.92%).

When the input voltage V_{dc} is 367V (high voltage range), the controller 21 controls the switch SW such that the first capacitor C₁ and the second capacitor C₂ are electrically connected in parallel, and thus, the variable capacitor C has a capacitance of 27 nF. This enables the LLC resonant circuit 22 to maintain high conversion efficiency without operating in a frequency that is too high (the first power switch S₁ and the second power switch S₂ operating in a switching frequency that is not too high) to prevent errors in the switching of the first power switch S₁ and the second power switch S₂, as well as to prevent increase in EMI.

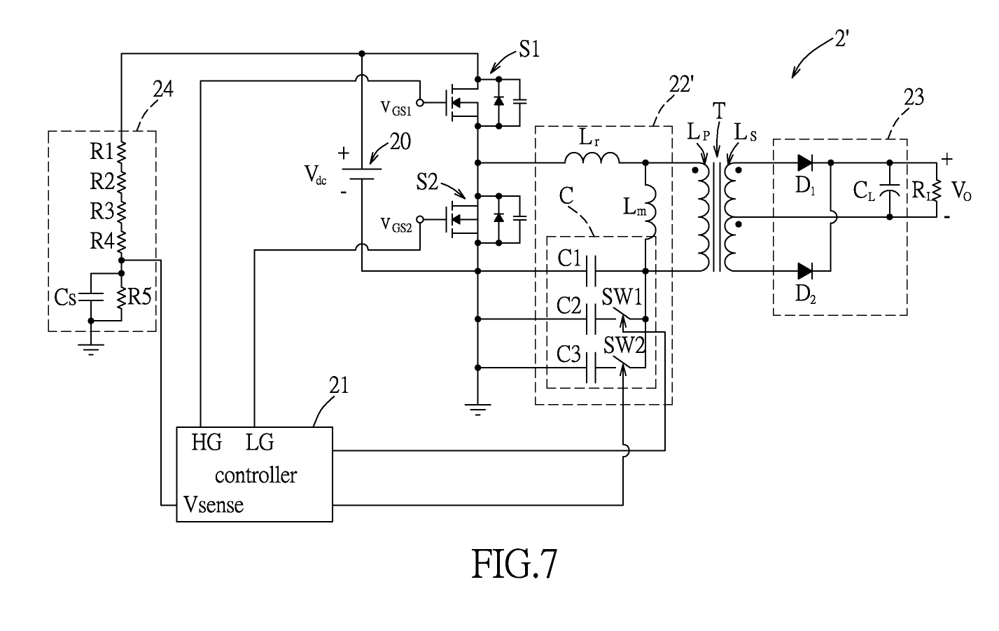

Referring to FIG. 7, a second embodiment of the LLC resonant power converter 2′ in the present invention differs from the first embodiment in several aspects:

The controller 21 of the LLC resonant power converter 2′ can vary the variable capacitor C in multi-levels that correspond to various voltage levels of the input voltage V_{dc}, i.e., the variable capacitor C of the LLC resonant circuit 22′ includes at least a first capacitor C1, a second capacitor C2, and a third capacitor C3. The first capacitor C1 is electrically coupled in series with the resonant inductor Lᵣ and the magnetizing inductor Lₘ.

The controller 21 controls a first switch SW1 and a second switch SW2 of the variable capacitor C to make or break parallel connection of the second capacitor C₂ and the third capacitor C₃ with the first capacitor C₁, respectively.

The controller 21 is operable, according to the magnitude of the input voltage V_{dc}, to control the variable capacitor C to have a capacitance equal to a capacitance of the first capacitor C₁, a capacitance of the second capacitor C₂, a capacitance of the third capacitor C₃, or a capacitance of a combination of at least two of the first capacitor C₁, the second capacitor C₂, and the third capacitor C₃, such that the capacitance of the variable capacitor C is increased or decreased according to the magnitude of the input voltage V_{dc}.

For example, the first capacitor C₁, the second capacitor C₂ having a capacitance greater than that of the first capacitor C₁, and the third capacitor C₃ having a capacitance greater than that of the second capacitor C₂ may be used in the variable capacitor C.

When the controller 21 determines that the input voltage V_{dc} is in a first voltage range (such as a lowest voltage range), the controller 21 controls the first switch SW₁ and the second SW₂ to break parallel connection of the second capacitor C₂ and the third capacitor C₃ with the first capacitor C₁, such that the variable capacitor C has a capacitance equal to the capacitance of the first capacitor C₁.

When the controller 21 determines that the input voltage V_{dc} is in a second voltage range that is greater than the first voltage range, the controller 21 controls the first switch SW₁ to make parallel connection of the second capacitor C₂ with the first capacitor C₁, such that the variable capacitor C has a capacitance equal to a combined capacitance of the first capacitor C₁ and the second capacitor C₂.

When the controller 21 determines that the input voltage V_{dc} is in a third voltage range that is greater than the second voltage range, the controller 21 controls the second switch SW₂ to make parallel connection of the third capacitor C₃ with the first capacitor C₁, such that the variable capacitor C has a capacitance equal to a combined capacitance of the first capacitor C₁ and the third capacitor C₃.

When the controller 21 determines that the input voltage V_{dc} is in a fourth voltage range that is greater than the third voltage range, the controller 21 controls the first switch SW₁ and the second switch SW₂ to make parallel connection of the third capacitor C₃, the second capacitor C₂ and the first capacitor C₁, such that the variable capacitor C has a capacitance equal to a combined capacitance of the first capacitor C₁, the second capacitor C₂, and the third capacitor C₃. By such virtue, the controller 21 controls a capacitance of the variable capacitor C according to a magnitude of the input voltage V_{dc}, such that the capacitance of the variable capacitor C is increased when the input voltage V_{dc} is increased, and that the capacitance of the variable capacitor C is decreased when the input voltage V_{dc} is decreased.

In other embodiments, the variable capacitor C can include N (N≧3) number of capacitors having different capacitances and N−1 switches, producing 2̂ (N−1) levels of capacitance. For example, four capacitors in combination with three switches can result in eight levels of capacitance, while five capacitors in combination with four switches can result in sixteen levels of capacitance.

In the second embodiment of the LLC resonant power converter 2′ in the present invention, the capacitance of the variable capacitor C can be varied in multi-levels to correspond with different levels of the input voltage V_{dc}, and thus, the resonant frequency fₛ of the LLC resonant circuit 22′ can be adjusted according to various voltage levels of the input voltage V_{dc}. This enables the resonant frequency fₛ to be at a desirable frequency for improving voltage conversion efficiency. Improved voltage conversion efficiency meets an energy saving requirement and trend, and decreases excess heat dissipation due to power consumption. Moreover, when the input voltage is high, the resonant frequency fₛ is not too high to prevent erroneous circuit operation and higher EMI, thereby increasing product reliability.

In summary, the controller 21 of the LLC resonant power converter 2,2′ can vary the resonant frequency fₛ of the LLC resonant circuit 22, 22′ to correspond with various voltage levels of the input voltage V_{dc}. During low input voltage V_{dc}, the LLC resonant circuit 22, 22′ operates at a higher resonant frequency fₛ for improving power conversion efficiency of the LLC resonant power converter 2, 2′. During high input voltage V_{dc}, the LLC resonant circuit 22, 22′ operates at a lower resonant frequency fₛ such that not only is power conversion efficiency of the LLC resonant power converter 2,2′ maintained, the LLC resonant circuit 22, 22′ operates at a frequency that is not too high to prevent erroneous circuit operation and higher EMI.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A LLC resonant power converter for converting an input voltage from a direct current power source into an output voltage, the input voltage being within a first voltage range or within a second voltage range that is greater than the first voltage range, the LLC resonant power converter comprising:
a first power switch;
a second power switch electrically coupled in series with the first power switch;
a transformer including a primary side coil and a secondary side coil;
a rectifying filter circuit electrically coupled with the secondary side coil;
a LLC resonant circuit electrically coupled between the second power switch and the primary side coil, the LLC resonant circuit including a resonant inductor, a magnetizing inductor, and a variable capacitor that are electrically connected in series, the variable capacitor being controllable to have a selected one of a first capacitance value and a second capacitance value, the first capacitance value being less than the second capacitance value; and
a controller that controls the first power switch and the second power switch to be alternately switched to an on-state and that is electrically coupled with the direct current power source and the variable capacitor, the controller controlling the variable capacitor to have the first capacitance value when the controller determines that the input voltage is within the first voltage range, and controlling the variable capacitor to have the second capacitance value when the controller determines that the input voltage is within the second voltage range.

2. The LLC resonant power converter as claimed in claim 1, wherein:
the variable capacitor includes a first capacitor electrically coupled in series with the resonant inductor and the magnetizing inductor, and having the first capacitance value, and a second capacitor, the second capacitance value being a sum of the first capacitance value and a capacitance value of the second capacitor;
when the controller determines the input voltage to be within the first voltage range, the controller controlling the variable capacitor to break parallel connection of the second capacitor with the first capacitor such that the variable capacitor has the first capacitance value; and
when the controller determines the input voltage to be within the second voltage range, the controller controlling the variable capacitor to make parallel connection of the second capacitor with the first capacitor such that the variable capacitor has the second capacitance value.

3. The LLC resonant power converter as claimed in claim 1, further comprising an input voltage detection circuit that includes at least one resistor electrically coupled with a positive terminal of the direct current power source;
the controller having a voltage detection terminal electrically coupled with the resistor for detecting a voltage drop value, and the controller determining whether the input voltage is within the first voltage range or the second voltage range based on the voltage drop value.

4. The LLC resonant power converter as claimed in claim 1, wherein the resonant inductor includes a leakage inductor of the primary side coil of the transformer.

5. The LLC resonant power converter as claimed in claim 4, wherein the resonant inductor further includes an inductor electrically coupled with the leakage inductor.

6. A LLC resonant power converter for converting an input voltage from a direct current power source into an output voltage, the LLC resonant power converter comprising:
a first power switch;
a second power switch electrically coupled in series with the first power switch;
a transformer including a primary side coil and a secondary side coil;
a LLC resonant circuit that is electrically coupled between the second power switch and the primary side coil, the LLC resonant circuit including a resonant inductor, a magnetizing inductor, and a variable capacitor that are electrically connected in series; and
a controller that controls the first power switch and the second power switch to be alternately switched to an on-state and that is electrically coupled with the direct current power source and the variable capacitor, the controller controlling a capacitance of the variable capacitor according to a magnitude of the input voltage, such that the capacitance of the variable capacitor is increased when the input voltage is increased, and that the capacitance of the variable capacitor is decreased when the input voltage is decreased.

7. The LLC resonant power converter as claimed in claim 6, wherein:
the variable capacitor includes a first capacitor, a second capacitor, and a third capacitor;
the controller is operable, according to the magnitude of the input voltage, to control the variable capacitor to have a capacitance equal to a capacitance of the first capacitor, a capacitance of the second capacitor, a capacitance of the third capacitor, or a capacitance of a combination of at least two of the first capacitor, the second capacitor, and the third capacitor, such that the capacitance of the variable capacitor is increased or decreased according to the magnitude of the input voltage.

8. The LLC resonant power converter as claimed in claim 6, further comprising an input voltage detection circuit that includes at least one resistor electrically coupled with a positive terminal of the direct current power source;
the controller having a voltage detection terminal electrically coupled with the resistor for detecting a voltage drop value, and the controller determining the magnitude of the input voltage based on the voltage drop value.

9. The LLC resonant power converter as claimed in claim 6, wherein the resonant inductor includes a leakage inductor of the primary side coil of the transformer.

10. The LLC resonant power converter as claimed in claim 6, wherein the resonant inductor includes a leakage inductor of the primary side coil of the transformer, and an inductor electrically coupled with the leakage inductor.

11. The LLC resonant power converter as claimed in claim 7, wherein the first capacitor, the second capacitor and the third capacitor have capacitance values that differ from one another.
